(19) United States
(12) Patent Application Publication
(10) Pub. No.: US 2008/0191566 A1
(43) Pub. Date: Aug. 14, 2008

(54) MOTOR AND STATOR STRUCTURE THEREOF

(76) Inventors: Yung-Ping Lin, Taoyuan Hsien (TW); Dung-Chang Yeh, Taoyuan Hsien (TW); Yi-Liang Gong, Taoyuan Hsien (TW); Hui Chu, Taoyuan Hsien (TW)

Correspondence Address: BIRCH STEWART KOLASCH & BIRCH, PO BOX 747, FALLS CHURCH, VA, 22040-0747, US

(21) Appl. No.: 12/025,598

(22) Filed: Feb. 4, 2008

(30) Foreign Application Priority Data
Feb. 12, 2007 (TW) 096105003

(51) Int. Cl. H02K 5/22

(52) U.S. Cl. 310/71; 310/89

(57) ABSTRACT

A stator structure of a motor includes a magnetically conducting element, a circuit board, a bus line and a housing. The magnetically conducting element has at least one coil. The circuit board is positioned adjacent to the magnetically conducting element and electrically connected to the coil. The bus line is electrically connected to the circuit board or the coil. The housing has a top part and a bottom part, which are disposed at two opposite sides of the magnetically conducting element. The top part or the bottom part has a first fastening structure. One end of the circuit board or the bus line is fixed to the first fastening structure.

### CROSS REFERENCE TO RELATED APPLICATIONS

This Non-provisional application claims priority under 35 U.S.C. §119(a) on Patent Application No(s). 096105003 filed in Taiwan, Republic of China on Feb. 12, 2007, the entire contents of which are hereby incorporated by reference.

### BACKGROUND OF THE INVENTION

1. Field of Invention

The invention relates to a motor and a stator structure thereof and, in particular, to a motor and a stator structure thereof that have an enhanced combining strength.

2. Related Art

Motors are the devices that can convert electrical energy into mechanical energy, and they are used to be disposed in many mechanical structures. As electronic devices become smaller, it is the trend to miniaturize the volume and increase the operating speed of the motor. It is therefore an important subject to maintain the long lifetime and high reliability of the motor under high-speed operations.

As shown in FIG. 1, a conventional stepping motor 1 includes a stator structure 11, a rotor structure 12, a circuit board 13, a bus line 16 and a housing structure 14. The stator structure 11 includes a bobbin 111 and a coil 112 wound around the bobbin 111 and electrically connected to the circuit board 13. The rotor structure 12 includes a rotating shaft 121 and a magnet 122 mounted around the rotating shaft 121. The stator structure 11 is mounted on the rotor structure 12. The housing structure 14 includes a body 141, a top part 142 and a bottom part 143. The body 141 accommodates the stator structure 11 and the rotor structure 12. The top part 142 and the bottom part 143 are disposed on the top side and the bottom side of the stator structure 11. Both ends of the coil 112 are wound on pins 15 of the bobbin 111, respectively. The pins 15 are then soldered onto the circuit board 13 and electrically connected with the bus line 16 via the circuit board 13. The electrical current from the bus line 16 flows through the coil 112 and produces a varying magnetic field for driving the motor 1 to rotate.

However, when assembling the above-mentioned motor 1, the components thereof are easy to be pulled by an external force, so that the bus line 16 and the circuit board 13 may shift toward a first direction D1 or a second direction D2. This will result in a disjunction between the pin 15 and the bobbin 111 or between the pin 15 and the circuit board 13. More seriously, this may cause the segregation of the components of the motor 1.

Therefore, it is an important subject to provide a motor and a stator structure that have enhanced combining strength so as to increase the lifetime and reliability thereof.

### SUMMARY OF THE INVENTION

In view of the foregoing, the invention is to provide a motor with enhanced combining strength and the stator structure thereof.

To achieve the above, the invention discloses a stator structure of a motor. The stator structure includes a magnetically conducting element, a circuit board, a bus line and a housing. The magnetically conducting element has at least one coil. The circuit board is positioned adjacent to the magnetically conducting element and electrically connected to the coil. The bus line is electrically connected to the circuit board or the coil. The housing has a top part and a bottom part, which are disposed on two opposite sides of the magnetically conducting element. The top part or the bottom part has a first fastening structure, and the bus line or one end of the circuit board is fixed to the first fastening structure.

To achieve the above, the invention also discloses a motor including a stator structure and a rotor structure disposed and corresponding to the stator structure. The stator structure includes a magnetically conducting element, a circuit board, a bus line and a housing. The magnetically conducting element has at least one coil. The circuit board is positioned adjacent to the magnetically conducting element and electrically connected to the coil. The bus line is electrically connected to the circuit board or the coil. The housing has a top part and a bottom part disposed on two opposite sides of the magnetically conducting element. The top part or the bottom part has a first fastening structure, and the bus line or the one end of the circuit board is fixed to the first fastening structure.

As mentioned above, the motor and the stator structure thereof of the invention have at least one fastening structure (such as the first fastening structure or the second fastening structure) formed on the top part or the bottom part of the housing to fix the circuit board or bus line. Therefore, if the circuit board or the bus line is pulled by a force, the fastening structure can provide an appropriate resisting force, which prevents the electrically conducting element from falling off the bobbin or the circuit board. Accordingly, the lifetime and reliability of the motor can be increased.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration of a conventional stepping motor;

FIG. 2 is a schematic illustration of a motor according to a first embodiment of the invention;

FIG. 3 is a schematic illustration of a motor according to a second embodiment of the invention;

FIG. 4 is a schematic illustration of a bottom part of FIG. 3;

FIG. 5 is a schematic illustration of a motor according to a third embodiment of the invention; and

FIG. 6 is a schematic illustration of a motor according to a fourth embodiment of the invention.

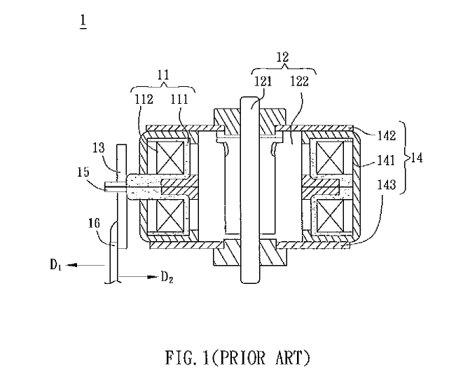

### DETAILED DESCRIPTION OF THE INVENTION

The present invention will be apparent from the following detailed description, which proceeds with reference to the accompanying drawings, wherein the same references relate to the same elements.

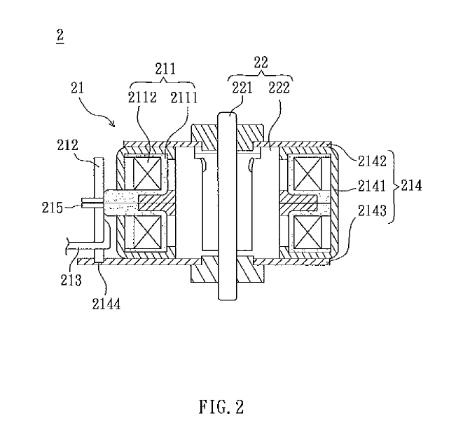

With reference to FIG. 2, a motor 2 according to a first embodiment of the invention includes a stator structure 21 and a rotor structure 22. In the embodiment, the motor 2 can be a brush motor, a brushless motor or a stepping motor.

The stator structure 21 includes a magnetically conducting element 211, a circuit board 212, a bus line 213 and a housing 214.

The rotor structure 22 is disposed and corresponding to the stator structure 21. The rotor structure 22 includes a rotating shaft 221 and a magnetic element 222 connected with the rotating shaft 221. The magnetic element 222 can be a permanent magnet. As shown in FIG. 2, the stator structure 21 is telescoped to the rotor structure 21 to form the motor 2.

The magnetically conducting element 211 of the stator structure 21 has a bobbin 2111 and at least one coil 2112 wound around the bobbin 2111. The circuit board 212 is positioned adjacent to the magnetically conducting element 211 and electrically connected with the coil 2112. In this embodiment the stator structure 21 further includes at least one electrically conducting element 215 electrically connected with the coil 2112 and the circuit board 212. The electrically conducting element 215 can be a metal sheet or a metal rod. Explicitly speaking, the circuit board 212 is positioned on one side of the magnetically connecting element 211. The electrically conducting element 215 is embedded on the bobbin 2111, and both ends of the coil 2112 are wound around the electrically conducting element 215. Furthermore, the coil 2112 is electrically connected with the circuit board 212 by soldering the electrically conducting element 215 onto the circuit board 212. According to different needs in practice, several electrically conducting elements 215 are disposed and corresponding to several coils 2112.

The bus line 213 is electrically connected with the circuit board 212 or the coil 2112 of the magnetically conducting element 211. The bus line 213 is soldered onto the circuit board 212 and electrically connected with the coil 2112 via the circuit board 212. The bus line 213 is used to provide an electrical current to the coil 2112, so that the coil 2112 can generate a varying magnetic field. The magnetic field interacts with the magnetic element 222 of the rotor structure 22 to drive the motor 2 into rotation. In this embodiment, the bus line 213 and the circuit board 212 are, for example but not limited to, separate components. Alternatively, the bus line 213 and the circuit board 212 can also be formed as a single unit.

The housing 214 has a body 2141, a top part 2142 and a bottom part 2143. The body 2141 is connected with the top part 2142 and the bottom part 2143. The body 2141 accommodates the stator structure 21 and the rotor structure 22. The top part 2142 and the bottom part 2143 are disposed on two opposite sides of the magnetically conducting element 211. As shown in FIG. 2, the top part 2142 and the bottom part 2143 are disposed on the top side and the bottom side of the magnetically conducting element 211 and next to the circuit board 212.

In this embodiment, the top part 2142 or the bottom part 2143 has a first fastening structure 2144. For example, as illustrated in FIG. 2, the first fastening structure 2144 is disposed on the bottom part 2143. One end of the circuit board 212 is fixed on the first fastening structure 2144 in order to resist the pulling force imposed thereon while assembly or collisions. In this embodiment, the first fastening structure 2144 can be a hole, a concave or a guiding groove that is designed in accord with the circuit board 212. Besides, the bus line 213 passes through the circuit board 212 and is extended to the outside of the motor 2.

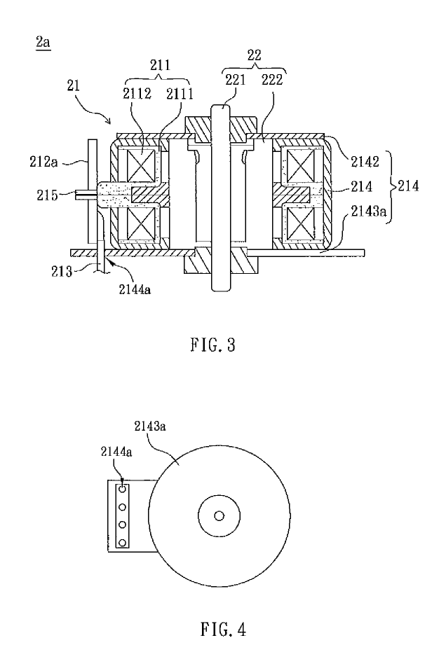

FIG. 3 illustrates a motor 2a according to a second embodiment of the invention. The motor 2a is different from the motor 2 in FIG. 2 in that the bottom part 2143a of the motor 2a has another type of first fastening structure 2144a for fixing the bus line 213 so as to resist the pulling force imposed thereon during assembly or collisions. FIG. 4 is a schematic illustration of the bottom part 2143a of the motor 2a. The first fastening structure 2144a is a plurality of holes, and the holes can be circular holes or line holes. Moreover, using the first fastening structure 2144a to constrain the bus line 213 can effectively reduce the possibility that the electrically conducting element 215 and the circuit board 212a depart from each other or that the electrically conducting element 215 and the bobbin 2111 depart from each other. Accordingly, the segregation of the devices of the motor can be avoided.

The above embodiments with the first fastening structure 2144 or 2144a disposed on the bottom part 2143 or 2143a are only examples of the invention. The first fastening structure 2144 or 2144a can also be disposed on the top part 2142 as well.

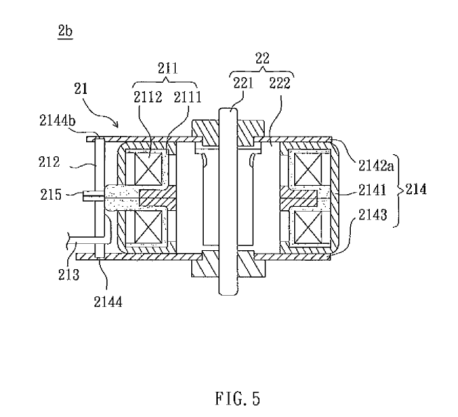

FIG. 5 shows a motor 2b according to a third embodiment of the invention. As shown in FIG. 5, the top part 2142a is further provided with a second fastening structure 2144b. Both ends of the circuit board 212 are fixed in the first fastening structure 2144 and the second fastening structure 2144b, respectively, so that the circuit board 212 can be supported and fixed more properly. In this embodiment, the second fastening structure 2144b can be a hole, a concave, a guiding groove, or a stop plate.

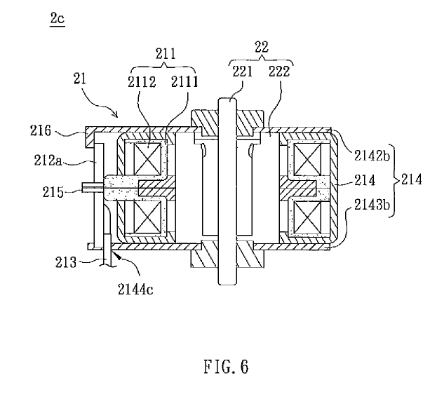

FIG. 6 shows a motor 2c according to a fourth embodiment of the invention. As shown in FIG. 6, a stop element 216, which can be a second fastening structure, protrudes from the top part 2142b, and the bottom part 2143b has a first fastening structure 2144c. The bus line 213 and one end of the circuit board 212a are fixed onto the first fastening structure 2144c. The other end of the circuit board 212a is stopped from pulling by the stop element 216. In this embodiment the circuit board 212a and the bus line 213 are simultaneously fixed by the first fixing structure 2144c. Therefore, the pulling force that the circuit board 212a and the bus line 213 can resist is increased, effectively avoiding the possibility that the electrically conducting element 215 and the circuit board 212a depart from each other or that the electrically conducting element 215 and the bobbin 2111 depart from each other.

In summary, the motor and the stator structure of the invention include at least one fastening structure (such as the first fastening structure or the second fastening structure) formed on the top part or the bottom part of the housing for fixing the circuit board or bus line. Therefore, if the circuit board or the bus line is pulled by a force, the fastening structure can provide an appropriate resisting force, which prevents the electrically conducting element from falling off the bobbin or the circuit board. Accordingly, the lifetime and reliability of the motor can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A stator structure of a motor, comprising:
a magnetically conducting element having at least one coil;
a circuit board positioned adjacent to the magnetically conducting element and electrically connected to the coil;
a bus line electrically connected to the circuit board or the coil; and
a housing having a top part and a bottom part disposed on two opposite sides of the magnetically conducting element, wherein the top part or the bottom part has a first fastening structure, and the bus line or the circuit board is fixed to the first fastening structure.

2. The stator structure of claim 1, wherein the first fastening structure is a hole, a concave, or a guiding groove.

3. The stator structure of claim 1, further comprising a stop element disposed on the top part or the bottom part for stopping the circuit board.

4. The stator structure of claim 1, further comprising at least one electrically conducting element connected to the coil and the circuit board.

5. The stator structure of claim 4, wherein the electrically conducting element is a metal sheet or a metal rod.

6. The stator structure of claim 1, wherein the top part or the bottom part further comprises a second fastening structure, and the bus line or the circuit board is fixed to the second fastening structure.

7. The stator structure of claim 6, wherein the second fastening structure is a hole, a concave, a stop plate, a stop element or a guiding groove.

8. The stator structure of claim 1, wherein the circuit board and the bus line are formed as a single unit or separate components.

9. The stator structure of claim 1, wherein the magnetically conducting element further comprises a bobbin, and the coil is wound around the bobbin.

10. A motor comprising:
a rotor structure; and
a stator structure disposed corresponding to the rotor structure, and comprising:
a magnetically conducting element having at least one coil;
a circuit board positioned adjacent to the magnetically conducting element and electrically connected to the coil;
a bus line electrically connected to the circuit board or the coil; and
a housing having a top part and a bottom part disposed on two opposite sides of the magnetically conducting element, wherein the top part or the bottom part has a first fastening structure, and the bus line or the circuit board is fixed to the first fastening structure.

11. The motor of claim 10, wherein the first fastening structure is a hole, a concave, or a guiding groove.

12. The motor of claim 10, wherein the stator structure further comprises a stop element disposed on the top part or the bottom part for stopping the circuit board.

13. The motor of claim 10, wherein the stator structure further comprises at least one electrically conducting element connected to the coil and the circuit board.

14. The motor of claim 13, wherein the electrically conducting element is a metal sheet or a metal rod.

15. The motor of claim 10, wherein the top part or the bottom part further comprises a second fastening structure, and the bus line or the circuit board is fixed to the second fastening structure.

16. The motor of claim 15, wherein the second fastening structure is a hole, a concave, a stop plate, a stop element or a guiding groove.

17. The motor of claim 10, wherein the circuit board and the bus line are formed as a single unit or separate components.

18. The motor of claim 10, wherein the magnetically conducting element further comprises a bobbin, and the coil is wound around the bobbin.

19. The motor of claim 10 being a brush motor, a brushless motor, or a stepping motor.
